(19) United States
(12) Patent Application Publication
(10) Pub. No.: US 2025/0380209 A1
(43) Pub. Date: Dec. 11, 2025

(54) SERVICE CONTINUITY DURING NETWORK REPOSITORY FUNCTION (NRF) OUTAGE IN MODEL D COMMUNICATION IN A 5TH GENERATION NETWORK

(71) Applicants: DISH Network Technologies India Private Limited, Bangalore (IN); DISH Wireless L.L.C., Englewood, CO (US)

(72) Inventors: Brijesh Kumar Mishra, Bengaluru (IN); Ankesh Arora, Bengaluru (IN); Arun Thomas, BENGALURU (IN); Bhasker Singh Negi, Ghaziabad (IN); Anupam Jindal, Bengaluru (IN); MythriAmulya Sabhapati, Highlands Ranch, CO (US); Kulasekaran Srinivasan, Chennai (IN); Arun Kumar Pradhan, Bengaluru (IN)

(21) Appl. No.: 18/735,076

(22) Filed: Jun. 5, 2024

(51) Int. Cl. H04W 48/16

(52) U.S. Cl. CPC H04W 48/16

(57) ABSTRACT

In response to receiving a service request from a second computing node to consume a service provided by a target network function, a first computing node determines whether the NRF is available to process a request from the first computing node to perform a discovery procedure to determine a computing node that implements the target network function. When the NRF is unavailable, the first computing node searches discovery records of previous discovery procedures performed by the first computing node and identifies a third computing node that implements the target network function. The first computing node forwards the service request to the identified third computing node.

### TECHNICAL FIELD

The present disclosure relates generally to wireless communications, and more specifically to maintaining service continuity during Network Repository Function (NRF) outage in model D communication in a 5^{th} Generation (5G) network.

### BACKGROUND

In some cases, when implementing communications between network functions (NF) of a 5G core network in accordance with model B, C, and/or D, a consumer NF instance may be unable to perform and/or complete a discovery procedure due to unavailability of the network function (NF) repository function (NRF). This may cause an interruption in service as the consumer NF instance may not determine a producer NF instance that implements a desired service. In some cases, when implementing NF-NF communications in accordance with model D, a service interruption may occur because of error and/or failure of SCP.

### SUMMARY

The system and methods implemented by the system as disclosed in the present disclosure provide service continuity in the event of NRF failure and/or SCP failure. The disclosed system and methods may provide several practical applications and technical advantages. For example, one embodiment of the disclosed system provides the practical application of avoiding service interruption in the event of NRF error and/or NRF failure during NF-NF communications based on models B, C and/or D. As described in embodiments of the present disclosure, a first computing node that implements a consumer NF may determine that the first computing node is to consume a service provided by a target network function associated with the 5G core network. In response to determining that the NRF is unavailable to process a request to perform a discovery procedure, the first computing node accesses a local memory of the first computing node that stores discovery records of previous discovery procedures performed by the first computing node, wherein each discovery record comprises discovery results of a previous discovery procedure performed by the first computing node. The first computing node searches the discovery records for other computing nodes that implement the target network function. In response to determining, based on the search, a discovery record associated with a second computing node that implements the target network function, the first computing node extracts a network address of the second computing node from the determined discovery record and transmit a service request associated with consuming the service provided by the target network function implemented by the second computing node at the extracted network address.

In additional embodiments, a first computing node that implements a Service Communication Proxy (SCP) associated with the 5G network receives a service request from a second computing node to consume a service provided by a target network function of the 5G core network. In response to determining that the NRF is unavailable to process a request to perform a discovery procedure, the first computing node accesses a local memory of the first computing node that stores discovery records of previous discovery procedures performed by the first computing node, wherein each discovery record comprises discovery results of a previous discovery procedure performed by the first computing node. The first computing node searches the discovery records for other computing nodes that implement the target network function. In response to determining, based on the search, a discovery record associated with a third computing node that implements the target network function, the first computing node extracts a network address of the third computing node from the determined discovery record and forwards the service request to the third computing node. The first computing node then routes one or more messages between the second computing node and the third computing node to allow a first network function implemented by the second computing node to consume the service provided by the target network function implemented by the third computing node.

By proactively detecting NRF availability and switching to locally stored discovery records when the NRF is unavailable, the disclosed system and method avoid a computing node from continually attempting to re-run discovery procedures with the NRF. This saves processing resources and network bandwidth which would otherwise be used to re-run the discovery procedures multiple times even when the NRF is unavailable to process discovery requests. In addition, by promptly determining (e.g., from locally stored discovery records) a computing node that implements a desired target network function, the disclosed system and method avoids interruption in communication between computing nodes of a 5G core network, which in turn avoids service interruption in a 5G communication network. Avoiding service interruption increases data throughput in the 5G communication network, thus improving performance of the 5G communication network. Thus, the disclosed system and method generally improve cellular communication technology including 5G NR technology.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example cellular communication system, in accordance with embodiments of the present disclosure;

FIG. 2A illustrates an example Model A communication;

FIG. 2B illustrates an example Model B communication;

FIG. 2C illustrates an example Model C communication;

FIG. 2D illustrates an example Model D communication;

FIG. 3 illustrates an example system that implements NF-NF communication based on model B and/or model C, in accordance with one or more embodiments of the present disclosure;

FIG. 4 illustrates an example system that implements NF-NF communications based on model D, in accordance with one or more embodiments of the present disclosure;

FIG. 5 is a flowchart of an example method for service continuity in model B and C communications during NRF outage, in accordance with embodiments of the present disclosure; and

FIG. 6 is a flowchart of an example method for service continuity in model D communications during NRF outage, in accordance with embodiments of the present disclosure.

### DETAILED DESCRIPTION

### System Overview

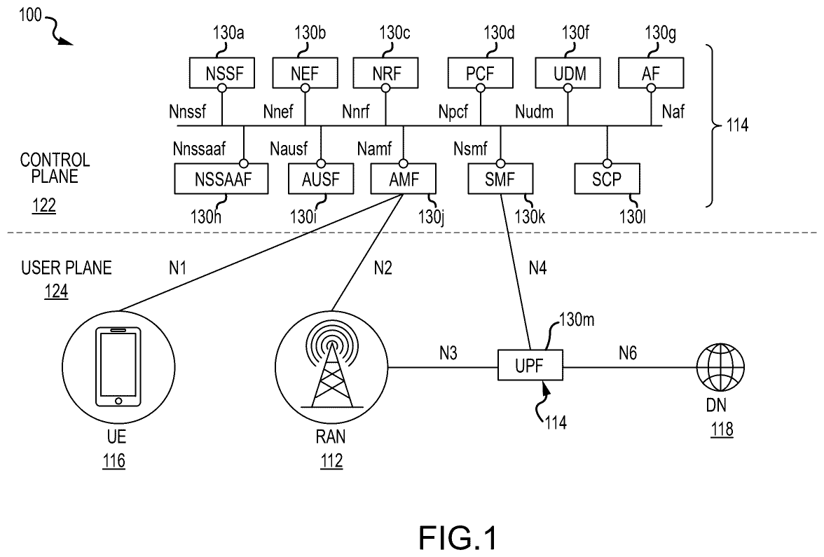

FIG. 1 illustrates an example architecture of a 5^{th} Generation (5G) network 100, in accordance with embodiments of the present disclosure. As shown in FIG. 1, the 5G network 100 includes 5G Radio Access Network (RAN) 112 and a 5G core network 114. The 5G RAN 112 includes a plurality of gNBs (not shown), where “g” stands for “5G” and “NB” for “Node B”, which is a name inherited from 3G onwards to refer to a radio transmitter. Each gNB provides connectivity between a UE 116 and the 5G core network 114. As illustrated in FIG. 1 and described below, the architecture of the 5G core network 114 relies on a “Service-Based Architecture” (SBA) framework, where the architectural elements are defined in terms of “Network Functions” (NFs) 130 (shown as 130a-130m) rather than by traditional network entities. Via interfaces of a common framework, any given NF 130 provides its services to all the other authorized NFs 130 and/or to any consumers that are permitted to make use of these provided services. Such an SBA approach provides modularity and reusability.

FIG. 1 illustrates several such example network functions 130 that may make up the 5G core network 114 including Network Slice Selection Function (NSSF) 130a, Network Exposure Function (NEF) 130b, Network Repository Function (NRF) 130c, Policy Control Function (PCF) 130d, Unified Data Management (UDM) 130e, Application Function (AF) 130f, Network Slice Specific Authentication and Authorization Function (NSSAF) 130h, Authentication Server Function (AUSF) 130i, Access and Mobility Management Function (AMF) 130j, Session Management Function (SMF) 130k, Service Communication Proxy (SCP) 1301 and User Plane Function (UPF) 130m. The network functions 130 shown in FIG. 1 are likely to be used in most of the 5G networks but depending on real deployment there may be more components or in some cases (e.g., small scale private networks) there may be less components where multiple functionalities are aggregated into one component.

As shown in FIG. 1, the network functions 130 of the 5G core network 114 are logically split into a control plane 122 and a user (or data) plane 124. The network functions 130 included in the control plane 122 are responsible for control functions such as user connection management, quality of service (QOS) policies, performing user authentication, etc. The network functions 130 in the user plane 124 handle data traffic. As shown, the network functions included in the control plane 122 are NSSF 130a, NEF 130b, NRF 130c, PCF 130d, UDM 130f, AF 130g, NSSAF 130h, AUSF 130i, AMF 130j, SMF 130k, and SCP 1301. The user plane 124 includes the UPF 130m. As shown in FIG. 1, UPF 130m manages data connectivity between the UE 116 and the data network 118 which is also part of the user plane 124.

Some of the key network functions of the 5G core network 1114 will now be described.

NSSF 130a is a control plane function within 5G core network 114 and supports functions for network slicing.

NEF 130b supports exposure of network functions capabilities in the 5G network to external network functions such as 3rd party application functions.

NRF 130c is used for service discovery of network functions and allows every network function to discover the service list provided by other network functions in the 5G core network 114.

PCF 130d provides policy rules to control plane functions (e.g., AMF) to enforce them and accesses subscription information relevant for policy decisions in a Unified Data Repository (UDR).

UDM 130f in charge of creating the credentials needed for authentication, granting access depending on user subscription, and sending those credentials to the other network functions. It retrieves the credentials from the UDR. Different key 5G features are supported by the UDM network function. In order to complete the authentication process, it creates authentication credentials. Based on user subscriptions, it approves network access and roaming.

AUSF 130i is responsible to handle authentication requests for both, 3GPP access and untrusted non-3GPP access.

AMF 130j is a key control plane component and has a large number of responsibilities including Registration management, Connection management, Reachability management, Mobility Management, Access Authentication, Access Authorization.

SMF 130k primarily handles session management.

SCP 1301 is responsible for message forwarding and routing to destination network function.

UPF 130m is responsible for routing and forwarding user plane data packets between gNB 114 and external data network 118. It handles downlink packet buffering and downlink data notification triggering. UPF 130m may also act as an anchor point for Intra-/Inter-RAT mobility when applicable.

Each network function 130 shown in FIG. 1 may be implemented by one or more computing nodes (e.g., one or more computing servers). In one embodiment, one or more network functions 130 may be implemented by cloud instances of a cloud network. According to 5G terminology, a computing node that implements a network function 130 may be referred to as an NF instance, wherein an NF instance may be a computing server or a cloud instance that implements one or more network functions 130. It may be noted that the terms “computing node” and “NF instance” may be used interchangeably throughout this disclosure. A single computing node or NF instance may implement multiple network functions 130. Additionally, or alternatively, multiple computing nodes or NF instances may implement a same network function 130.

In accordance with 3^{rd} Generation Partnership Project (3GPP) standards, each network function 130 exposes its functionality through a Service Based Interface (SBI), which employs a well-defined REST interface using HTTP/2. A network function 130 that consumes a service provided/exposed by another network function 130 is generally referred to as a consumer NF. A network function 130 that provides/exposes a service for use by another network function 130 is generally referred to as a producer NF. Certain network functions 130 may provide services as well as consume services provided by other network functions 130. Thus, a single network function 130 may act as a producer NF as well as a consumer NF.

In some cases, the Network Resource Function (NRF) 130c implements the new service-based architecture in the 5G core network 114 and serves as a centralized repository for all NF instances/computing nodes that implement one or more network functions 130. The NRF 130c is in charge of managing the lifecycle of NF profiles associated with the network functions 130, which includes registering new profiles, updating old ones, and deregistering those that are no longer in use. The NRF 130c provides a standards-based API for 5G NF registration and discovery. Generally, NRF 130c operates by storing data relating to all NF instances that implement network functions 130, including their supported functionalities, services, and capacities. When a new NF instance is instantiated, it registers with the NRF 130c, providing all the necessary details. Subsequently, any NF instance that needs to consume services provided by a producer network function 130 may query the NRF 130c for details of a target NF instance that implements the producer network function. Upon receiving this query, the NRF 130c responds with the most suitable NF instance information based on the requested service and capacity.

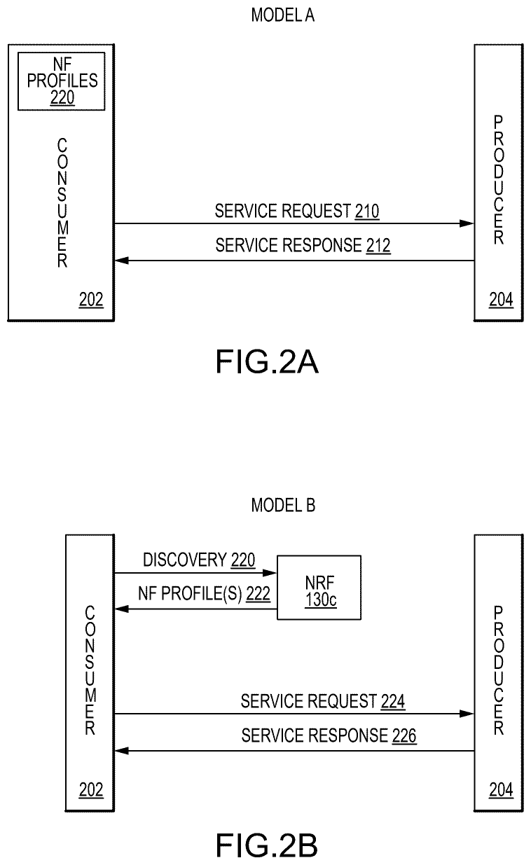

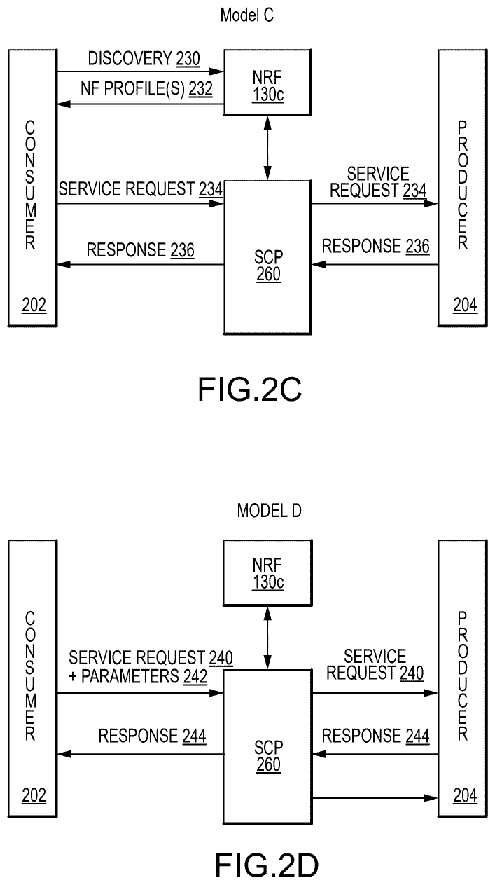

The 3GPP standards specify several communication models that network functions 130 may use to interact with each other. Communication models A and B are defined for direct communications between a consumer NF and a producer NF. Communication models C and D are defined for indirect communications between a consumer NF and a producer NF. FIG. 2A illustrates an example Model A communication. FIG. 2B illustrates an example Model B communication. FIG. 2C illustrates an example Model C communication. FIG. 2D illustrates an example Model D communication.

In model A communications shown in FIG. 2A, a consumer NF instance 202, which implements a consumer NF 130, is configured with NF profiles 222 of producer NF instances 204 implementing producer NFs 130 and directly communicates with a producer NF instance 204 of their choice. For example, the consumer NF instance 202 selects, from its local configuration (e.g., NF profiles 222), a producer NF instance 204 implementing a desired producer NF 130 and directly sends a service request 210 to the selected producer NF instance 204. As shown, the consumer NF instance 202 may receive a service response 212 from the producer NF instance 204 including the desired service.

In model B communications shown in FIG. 2B, a consumer NF instance 202, which implements a consumer NF 130, performs a discovery procedure by querying the NRF 130c (e.g., an NF instance that implements the NRF 130c) for a producer NF instance 204 that implements a desired producer NF 130. As shown, the consumer NF instance 202 transmits a discovery request 220 to a computing node/NF instance that implements the NRF 130c. The discovery request 220 includes an indication of the producer NF 130 from which the consumer NF 130 desires to consume a desired service. The discovery request 220 initiates a discovery procedure causing the NRF 130c to search for producer NF instances 204 that implement the desired producer NF 130. The NRF 130c returns NF profiles 222 of one or more producer NF instances 204 that implement the desired producer NF 130. The consumer NF instance 202 selects a producer NF instance 204 from the received discovery results and sends a service request 224 to the selected producer NF instance 204. As shown, the consumer NF instance 202 may receive a service response 226 from the producer NF instance 204 including the desired service.

In model C communications shown in FIG. 2C, like model B communications discussed with reference to FIG. 2B, a consumer NF instance 202, which implements a consumer NF 130, performs a discovery procedure by querying the NRF 130c (e.g., an NF instance that implements the NRF 130c) for a producer NF instance 204 that implements a desired producer NF 130. As shown, the consumer NF instance 202 transmits a discovery request 230 to a computing node/NF instance that implements the NRF 130c. The discovery request 230 includes an indication of the producer NF 130 from which the consumer NF 130 desires to consume a desired service. The discovery request 230 initiates a discovery procedure causing the NRF 130c to search for producer NF instances 204 that implement the desired producer NF 130. The NRF 130c returns NF profiles 232 of one or more producer NF instances 204 that implement the desired producer NF 130. In model C communications, a Service Communication Proxy (SCP) 260 is used to route messages between the consumer NF instance 202 and a producer NF instance 204 (also known as “indirect communications”) optimizing traffic routing with additional capabilities such as load balancing and alternate routing. In one embodiment, the consumer NF instance 202 selects a producer NF instance 204 from a set of producer NF instances 204 received as part of the discovery results from the NRF 130c and sends a service request 234 to the SCP 260 (e.g., to a computing node that implements the SCP 260) containing the address of the selected producer NF instance 204. In an alternative embodiment, the consumer NF instance 202 forwards to the SCP 260 addresses of the set of producer NF instances 204 received from the NRF 130c and the SCP selects a particular producer NF instance 204 from the set. The SCP routes the service request 234 to the selected producer NF instance 204. As shown, the SCP 260 routes a response 236 from the producer NF instance 204 to the consumer NF instance 202.

In model D communications shown in FIG. 2D, the SCP 260 is used for NF discovery as well as to route messages between a consumer NF instance 202 and a producer NF instance 204. This type of communication is referred to as indirect communication with delegated discovery. As shown in FIG. 2D, the consumer NF instance 202 transmits a service request 240 including a set of discovery parameters 242 to the SCP 260 (e.g., a computing node that implements the SCP 260). The discovery parameters 242 include an indication of a producer NF 130 from which the consumer NF instance 202 desires to consume a desired service. The SCP 260 performs the discovery procedure with the NRF 130c (e.g., an NF instance that implements the NRF 130c) based on the discovery parameters 242 received from the consumer NF instance 202. The NRF 130c returns NF profiles 232 of one or more producer NF instances 204 that implement the desired producer NF 130. When the discovery results include addresses of several producer NF instances 204, the SCP 260 selects a particular producer NF instance 204 from the set based on selection parameters received from the consumer NF instance 202 as part of the service request 240. The SCP 260 routes the service request 240 to the selected producer NF instance 204. As shown, the SCP 260 routes a response 244 from the producer NF instance 204 to the consumer NF instance 202.

It may be noted that 3GPP TS 23.501 describes NF discovery and NF-NF communication using models A, B, C and D in more detail and those details will not be reproduced here.

In some cases, when implementing NF-NF communications in accordance with model B, C, and/or D, a consumer NF instance 202 may be unable to perform and/or complete a discovery procedure due to unavailability (e.g., NRF error and/or NRF failure) of the NRF 130c. This may cause an interruption in service as the consumer NF instance 202 may not determine a producer NF instance 204 that implements a desired service. Additionally, or alternatively, when implementing NF-NF communications in accordance with model D, a service interruption may occur because of error and/or failure of SCP 260.

Embodiments of the present disclosure describe techniques for avoiding service interruption in the event of NRF error and/or NRF failure during NF-NF communications based on models B, C and/or D. The disclosed embodiments include techniques for avoiding service interruption in the event of SCP error and/or SCP failure during NF-NF communications based on model D.

### Service Continuity in Model B and C Communications During NRF Outage

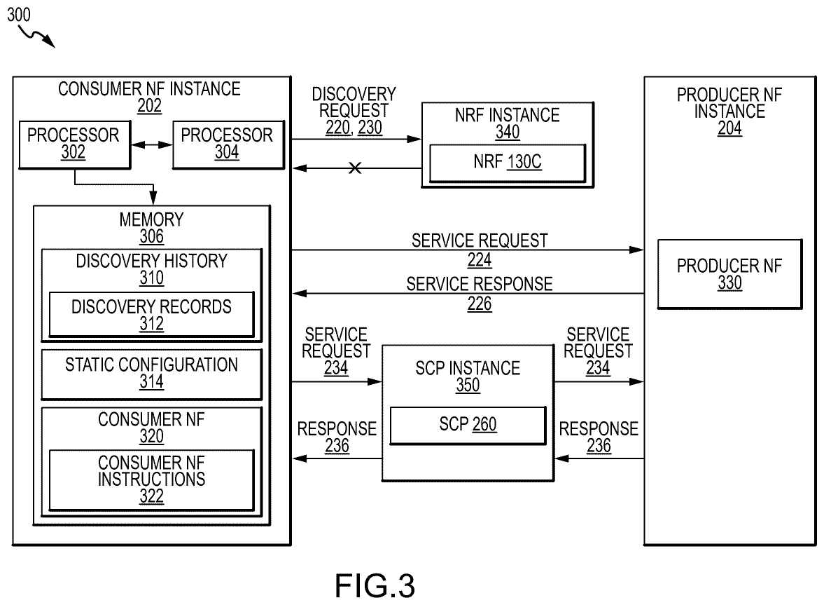

FIG. 3 illustrates an example system 300 that implements NF-NF communication based on model B and/or model C, in accordance with one or more embodiments of the present disclosure. As shown in FIG. 3, system 300 includes a consumer NF instance 202, a producer NF instance 204, an NRF instance 340 and an SCP instance 350. The consumer NF instance 202 is a computing node (e.g., a computing server, cloud instance etc.) that implements a consumer NF 320. The consumer NF 320 may be any one of the NFs 130 illustrated in FIG. 1. Similarly, the producer NF instance 204 is a computing node (e.g., a computing server, cloud instance etc.) that implements a producer NF 330. The producer NF 330 may be any one of the NFs 130 illustrated in FIG. 1. In one embodiment, the producer NF instance 204 may be one of several such producer NF instances 204 that implement the same producer NF 330. NRF instance 340 is a computing node (e.g., a computing server, cloud instance etc.) that implements the NRF 130c shown in FIG. 1. The SCP instance 350 (e.g., a computing server, cloud instance etc.) is a computing node (e.g., a computing server, cloud instance etc.) that implements the SCP 260 also shown in FIGS. 2C and 2D.

As shown in FIG. 3, consumer NF instance 202 may include a processor 302, a memory 306, and a network interface 304. The consumer NF instance 202 may be configured as shown in FIG. 3 or in any other suitable configuration.

The processor 302 comprises one or more processors operably coupled to the memory 306. The processor 302 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 306. The one or more processors are configured to process data and may be implemented in hardware or software. For example, the processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute software instructions (e.g., consumer NF instructions 322) to implement the consumer NF 320 and other operations associated with the consumer NF instance 202. In this way, processor 302 may be a special-purpose computer designed to implement the functions disclosed herein. In one or more embodiments, the consumer NF instance 202 is implemented using logic units, FPGAs, ASICs, DSPs, or any other suitable hardware.

The memory 306 comprises a non-transitory computer-readable medium such as one or more disks, tape drives, or solid-state drives, and may be used as an over-flow data storage device, to store programs when such programs are selected for execution, and to store instructions and data that are read during program execution. The memory 306 may be volatile or non-volatile and may comprise a read-only memory (ROM), random-access memory (RAM), ternary content-addressable memory (TCAM), dynamic random-access memory (DRAM), and static random-access memory (SRAM).

The memory 306 is operable to store a discovery history 310 including discovery records 312, static configuration 314, and consumer NF 320 including consumer NF instructions 322. The consumer NF instructions 322 may include any suitable set of instructions, logic, rules, or code operable to implement the consumer NF instance 202.

The network interface 304 is configured to enable wired and/or wireless communications. The network interface 304 is configured to communicate data between the consumer NF instance 202 and other devices, systems, or domains (e.g., producer NF instance 204, SCP instance 350 etc.). For example, the network interface 304 may comprise a Wi-Fi interface, a LAN interface, a WAN interface, a modem, a switch, or a router. The processor 302 is configured to send and receive data using the network interface 304. The network interface 304 may be configured to use any suitable type of communication protocol as would be appreciated by one of ordinary skill in the art.

It may be noted that any network function instance that implements one or more network functions 130 (e.g., producer NF, consumer NF etc.) may be implemented similar to the consumer NF instance 202 as shown in FIG. 3. For example, the producer NF instance 204 that implements the producer NF 330 may be implemented by a processor that executes instructions stored in a memory to implement the producer NF 330. Similarly, the SCP instance 350 that implements the SCP 260 may be implemented by a processor that executes instructions stored in a memory to implement the SCP 260.

As described above, when implementing NF-NF communication according to model B or model C, a consumer NF instance 202 implementing a consumer NF 320 performs a discovery procedure with an NRF instance 340 that implements the NRF 130c to determine a producer NF instance 204 that implements a producer NF 330 providing a desired service to be consumed by the consumer NF 320. For example, in response to determining that the consumer NF 320 is to consume a service provided by the producer NF 330, the consumer NF instance 202 transmits a discovery request 220 (model B)/230 (model C) to the NRF instance 340, wherein the discovery request 220/230 includes an indication of the producer NF 330 which provides a service to be consumed by the consumer NF 320. Generally, in response to receiving the discovery request 220/230, the NRF instance 340 searches for producer NF instances 204 that implement the desired producer NF 330 and transmits back NF profiles associated with one or more producer NF instances 204 that implement the desired producer NF 330, from which the consumer NF instance 202 may select a particular producer NF instance 204 for communication. However, in some cases, the consumer NF instance 202 may be unable to perform/complete the discovery procedure with the NRF instance 340 because of an error and/or failure of the NRF instance 340. The consumer NF instance 202 may determine whether the NRF instance 340 is available to perform the discovery procedure in several ways. For example, the consumer NF instance may periodically ping the NRF instance 340. The consumer NF instance 202 may determine that the NRF instance 340 is available if a response is received within a pre-configured time period from transmitting the ping. On the other hand, the consumer NF instance 202 may determine that the NRF instance 340 is unavailable in response to not receiving a response to a ping in the pre-configured time period. In an additional or alternative example, the consumer NF instance 202 may determine that the NRF instance 340 is available if a response to the discovery request 220/230 is received within a pre-configured time period starting from transmitting the discovery request 220/230. On the other hand, the consumer NF instance 202 may determine that the NRF instance 340 is unavailable to process the discovery request 220/230 in response to not receiving a response to the discovery request 220/230 within the pre-configured time period.

Upon detecting that the NRF instance 340 is unavailable to process the discovery request 220/230, the consumer NF instance 202 may be configured to access the discovery history 310 stored in the memory 306. The discovery history 310 stores discovery records 312 of previous discovery procedures performed by the consumer NF instance 202 with the NRF instance 340 or any other NRF instance that implements the NRF 130c. Each discovery record 312 includes results of a particular discovery procedure previously performed by the consumer NF instance 202, wherein the results may include, but are not limited to, NF profiles of one or more producer NF instances 204 including network address of the producer NF instances 204 and one or more services provided by each producer NF instance 204. 3GPP standards define a validity period associated with each NF instance determined as part of performing the discovery procedure with NRF 130c. Essentially, upon receiving discovery results from an NRF instance 340, the consumer NF instance 202 may communicate with and consume services from a producer NF instance 204 received as part of the discovery results only within the defined validity period. The producer NF instances 204 received as part of the discovery results from the NRF instance 340 become invalid upon expiration of the validity period. Generally, the consumer NF instance 202 deletes a discovery record 312 associated with a particular discovery procedure upon expiration of the validity period. However, in one or more embodiments, the consumer NF instance 202 may be configured to store the discovery records 312 beyond the respective validity periods (e.g., defined by 3GPP standards) associated with the respective discovery records 312. This allows the consumer NF instance 202 to use discovery results from a previously performed discovery procedure as a fallback option beyond the validity period of the discovery results and avoid service interruption in the event of NRF error/failure.

For example, upon detecting that the NRF instance 340 is unavailable to process the discovery request 220/230, the consumer NF instance 202 may be configured to access the discovery history 310 stored in the memory 306 and search the discovery records 312 for one or more producer NF instances 204 that implement the desired producer NF 330. Upon determining, based on the search, one or more discovery records 312 including NF profiles of producer NF instances 204 that implement the producer NF 330, the consumer NF instance 202 selects a producer NF instance 204 from the determined discovery records 312 and extracts the network address of the selected producer NF instance 204 from a respective discovery record 312. When implementing model B communications, the consumer NF instance 202 transmits a service request 224 to the producer NF instance 204 at the extracted network address of the producer NF instance 204. When implementing model C communications, the consumer NF instance 202 transmits a service request 234 to the SCP instance 350, wherein the service request 234 includes an indication (e.g., NF profile, network address etc.) of the selected producer NF instance 204. The SCP instance 350 is then responsible to route the service request 234 to the producer NF instance 204 at the network address of the producer NF instance 204 received from the consumer NF instance 202.

In certain embodiments, when the consumer NF instance 202 finds more than one discovery record 312 each including a producer NF instance 204 implementing the desired producer NF 330, the consumer NF instance 202 may be configured to select the producer NF instance 204 from the most recent discovery record 312.

In some cases, the consumer NF instance 202 may not find a discovery record 312 including a producer NF instance 204 that implements the desired producer NF 330. For example, the consumer NF instance 202 may not have performed a discovery procedure associated with the desired producer NF 330, and thus, no discovery record 312 of a producer NF instance implementing the producer NF 330 may exist. In response to not finding a discovery record 312 including a producer NF instance 204 that implements the desired producer NF 330, the consumer NF instance may fall back to a static configuration 314 stored in memory 306 and select the producer NF instance 204 from the static configuration 314. In this context, the consumer NF instance 202 may be configured to store the static configuration 314 that includes NF profiles (e.g., network addresses, services provided etc.) of pre-configured producer NF instances 204 implementing several network functions 130 of the 5G core network 114. In one embodiment, the static configuration 314 may include NF profiles of several pre-configured producer NF instances 204 for each network function 130. In other words, for a particular network function 130, the static configuration 314 may include NF profiles of several producer NF instances 204 that implement the particular network function 130. In one embodiment, in response to not finding a discovery record 312 including a producer NF instance 204 that implements the desired producer NF 330, the consumer NF instance may be configured to select from the static configuration a pre-configured producer NF instance 204 that implements the desired producer NF 330 and transmits a service request 224/234, as described above, for consuming the desired service from the selected producer NF instance 204. In one embodiment, the static configuration 314 may be associated with model A communications described with reference to FIG. 2A. Thus, by selecting the producer NF instance 204 from the static configuration 314 and communicating with the selected producer NF instance 204, the consumer NF instance 202 essentially switches to model A communications.

In some cases, the consumer NF instance 202 may determine that the NRF instance 340 is available to process the discovery request 220/230 but may be unable to successfully complete the discovery procedure with the NRF instance 340. For example, after transmitting the discovery request 220/230 to the NRF instance 340, the consumer NF instance 202 may receive incomplete results, erroneous results, may receive a response indicating that no producer NF instance 204 was found, or may not receive results at all within a pre-configured time period. In response to not completing the discovery procedure with the NRF instance 340, the consumer NF instance 202 may fall back to the static configuration 314 stored in memory 306 and select a pre-configured producer NF instance 204 from the static configuration 314. Subsequently, the consumer NF instance 202 may transmit a service request 224/234, as described above, for consuming the desired service from the selected producer NF instance 204.

In certain embodiments, before checking the availability of the NRF instance 340, the consumer NF instance 202 may be configured to check whether a dynamic configuration or the static configuration 314 is to be followed for consuming a service from the desired producer NF 330. In one embodiment, the consumer NF instance 202 may be configured to implement the dynamic configuration for consuming services from certain network functions 130 but may be configured to implement the static configuration 314 for consuming services from certain other network functions 130. Dynamic configuration includes performing a discovery procedure with the NRF instance 340 and selecting a producer NF instance 204 based on results of the discovery procedure. For example, in response to determining that the consumer NF instance 202 is configured to follow the dynamic configuration, the consumer NF instance 202 proceeds to check availability of the NRF instance 340 as described above and follows the subsequent operations discussed above. On the other hand, in response to determining that the consumer NF instance 202 is configured to follow the static configuration 314, the consumer NF instance 202 may select a pre-configured producer NF instance 204 from the static configuration 314. Subsequently, the consumer NF instance 202 may transmit a service request 224/234, as described above, for consuming the desired service from the selected producer NF instance 204. It may be noted that, in response to determining that the consumer NF instance 202 is configured to follow the static configuration 314, the consumer NF instance 202 does not attempt to perform the discovery procedure with the NRF instance 340 and selects a pre-configured producer NF instance 204 from the static configuration 314.

The consumer NF instance 202 may be configured to check (e.g., according to a pre-configured schedule) an operational status of each producer NF instance 204 that is part of the static configuration 314. Checking the status of a particular producer NF instance 204 includes checking whether the particular producer NF instance 204 is operational and can communicate with the consumer NF instance 202 to provide a desired service. For example, the consumer NF instance 202 may periodically transmit a status check message to a particular producer NF instance 204 and upon not receiving a response within a pre-configured time determine that the particular producer NF instance 204 is unresponsive and thus non-operational. In response to determining that a particular producer NF instance 204 is not operational, the consumer NF instance 202 may be configured to flag the particular producer NF instance 204 as non-operational to prevent selection of the particular producer NF instance 204 for communication with the consumer NF instance 202.

### Service Continuity in Model D Communications During NRF/SCP Outage

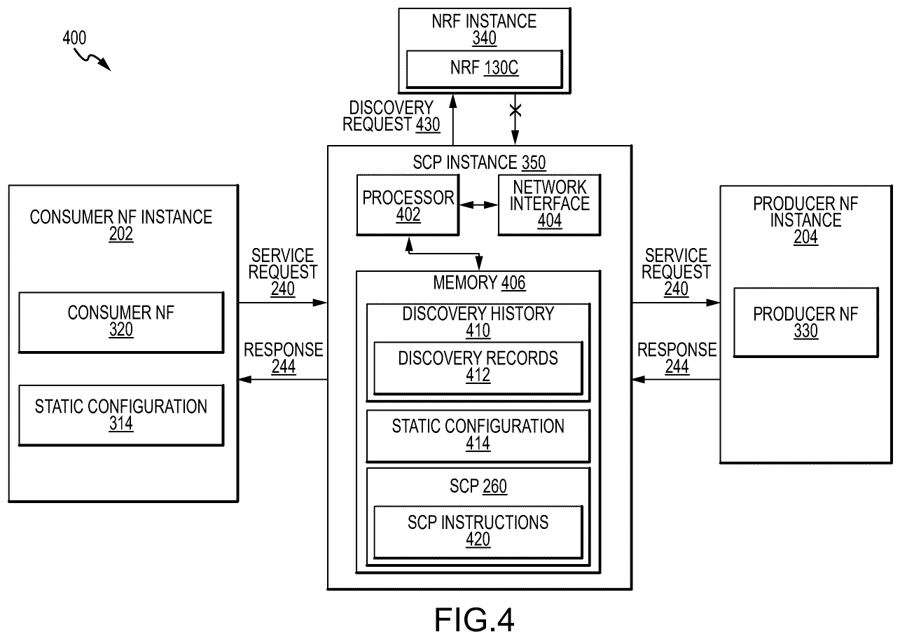

FIG. 4 illustrates an example system 400 that implements NF-NF communications based on model D, in accordance with one or more embodiments of the present disclosure. As shown in FIG. 4, system 400 includes a consumer NF instance 202, a producer NF instance 204, an NRF instance 340 and an SCP instance 350. The consumer NF instance 202 is a computing node (e.g., a computing server, cloud instance etc.) that implements a consumer NF 320. The consumer NF 320 may be any one of the NFs 130 illustrated in FIG. 1. Similarly, the producer NF instance 204 is a computing node (e.g., a computing server, cloud instance etc.) that implements a producer NF 330. The producer NF 330 may be any one of the NFs 130 illustrated in FIG. 1. In one embodiment, the producer NF instance 204 may be one of several such producer NF instances 204 that implement the same producer NF 330. NRF instance 340 is a computing node (e.g., a computing server, cloud instance etc.) that implements the NRF 130c shown in FIG. 1. The SCP instance 350 is a computing node (e.g., a computing server, cloud instance etc.) that implements the SCP 260 also shown in FIGS. 2C and 2D.

As shown in FIG. 4, SCP instance 350 may include a processor 402, a memory 406, and a network interface 404. The SCP instance 350 may be configured as shown in FIG. 4 or in any other suitable configuration.

The processor 402 comprises one or more processors operably coupled to the memory 406. The processor 402 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 402 may be a programmable logic device, a microcontroller, a microprocessor, or any suitable combination of the preceding. The processor 402 is communicatively coupled to and in signal communication with the memory 406. The one or more processors are configured to process data and may be implemented in hardware or software. For example, the processor 402 may be 8-bit, 16-bit, 32-bit, 64-bit or of any other suitable architecture. The processor 402 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute software instructions (e.g., SCP instructions 420) to implement the SCP instance 350 and other operations associated with the SCP instance 350. In this way, processor 402 may be a special-purpose computer designed to implement the functions disclosed herein. In one or more embodiments, the SCP instance 350 is implemented using logic units, FPGAs, ASICs, DSPs, or any other suitable hardware.

The memory 406 includes a non-transitory computer-readable medium such as one or more disks, tape drives, or solid-state drives, and may be used as an over-flow data storage device, to store programs when such programs are selected for execution, and to store instructions and data that are read during program execution. The memory 406 may be volatile or non-volatile and may comprise a read-only memory (ROM), random-access memory (RAM), ternary content-addressable memory (TCAM), dynamic random-access memory (DRAM), and static random-access memory (SRAM).

The memory 406 is operable to store a discovery history 410 including discovery records 412, static configuration 414, and SCP 260 including SCP instructions 420. SCP instance 350 may include any suitable set of instructions, logic, rules, or code operable to implement SCP instance 350.

The network interface 404 is configured to enable wired and/or wireless communications. The network interface 404 is configured to communicate data between the SCP instance 350 and other devices, systems, or domains (e.g., consumer NF instance 202, producer NF instance 204, etc.). For example, the network interface 404 may comprise a Wi-Fi interface, a LAN interface, a WAN interface, a modem, a switch, or a router. The processor 402 is configured to send and receive data using the network interface 404. The network interface 404 may be configured to use any suitable type of communication protocol as would be appreciated by one of ordinary skill in the art.

It may be noted that any network function instance that implements one or more network functions 130 (e.g., producer NF, consumer NF etc.) may be implemented similar to the SCP instance 350 as shown in FIG. 4. For example, as shown in FIG. 3, the consumer NF instance 202 that implements the consumer NF 320 may be implemented by processor 302 that executes consumer NF instructions 322 stored in memory 306 to implement the consumer NF 320. Similarly, the producer NF instance 204 that implements the producer NF 330 may be implemented by a processor that executes instructions stored in a memory to implement the producer NF 330.

As described above, when implementing NF-NF communication according to model D, the SCP 260 is used for delegated NF discovery as well as to route messages between a consumer NF instance 202 and a producer NF instance 204. As shown in FIG. 4, in response to determining that the consumer NF 320 is to consume a service provided by the producer NF 330, the consumer NF instance 202 transmits a service request 240 including a set of discovery parameters 242 (shown in FIG. 2D) to the SCP instance 350. The discovery parameters 242 include an indication of the producer NF 330 from which the consumer NF instance 202 desires to consume a desired service. The SCP instance 350 performs a discovery procedure with the NRF instance 340 based on the discovery parameters 242 received from the consumer NF instance 202. For example, the SCP instance 350 transmits a discovery request 430 to the NRF instance 340, wherein the discovery request 430 includes an indication of the producer NF 330 which provides a service to be consumed by the consumer NF 320. Generally, in response to receiving the discovery request 430, the NRF instance 340 searches for producer NF instances 204 that implement the desired producer NF 330 and transmits back NF profiles associated with one or more producer NF instances 204 that implement the desired producer NF 330, from which the SCP instance 350 may select a particular producer NF instance 204 for communication with the consumer NF instance 202. However, in some cases, the SCP instance 350 may be unable to perform/complete the discovery procedure with the NRF instance 340 because of an error and/or failure of the NRF instance 340. The SCP instance 350 may determine whether the NRF instance 340 is available to perform the discovery procedure in several ways. For example, the SCP instance 350 may periodically ping the NRF instance 340. The SCP instance 350 may determine that the NRF instance 340 is available if a response is received within a pre-configured time period of transmitting a pink to the NRF instance 340. On the other hand, the SCP instance 350 may determine that the NRF instance 340 is unavailable in response to not receiving a response to a ping in the pre-configured time period. In an additional or alternative example, the SCP instance 350 may determine that the NRF instance 340 is available if a response to the discovery request 430 is received within a pre-configured time period starting from transmitting the discovery request 430. On the other hand, the SCP instance 350 may determine that the NRF instance 340 is unavailable to process the discovery request 430 in response to not receiving a response to the discovery request 430 within the pre-configured time period.

Upon detecting that the NRF instance 340 is unavailable to process the discovery request 430, the SCP instance 350 may be configured to access the discovery history 410 stored in the memory 406. The discovery history 410 stores discovery records 412 of previous discovery procedures performed by the SCP instance 350 with the NRF instance 340 or any other NRF instance that implements the NRF 130c. Each discovery record 412 includes results of a particular discovery procedure previously performed by the SCP instance 350, wherein the results may include, but are not limited to, NF profiles of one or more producer NF instances 204 including network address of the producer NF instances 204 and one or more services provided by each producer NF instance 204. 3GPP standards define a validity period associated with each computing node determined as part of performing the discovery procedure with NRF 130c. Essentially, upon receiving discovery results from an NRF instance 340, a producer NF instance 204 received as part of the discovery results may be used for communication with the consumer NF instance 202 only within the defined validity period. The producer NF instances 204 received as part of the discovery results from the NRF instance 340 become invalid upon expiration of the validity period. Generally, the SCP instance 350 deletes a discovery record 412 associated with a particular discovery procedure upon expiration of the validity period. However, in one or more embodiments, the SCP instance 350 may be configured to store the discovery records 412 beyond the respective validity periods (e.g., defined by 3GPP standards) associated with the respective discovery records 412. This allows the SCP instance 350 to use discovery results from a previously performed discovery procedure as a fallback option beyond the validity period of the discovery results and avoid service interruption in the event of NRF error/failure.

For example, upon detecting that the NRF instance 340 is unavailable to process the discovery request 430, the SCP instance 350 may be configured to access the discovery history 410 stored in the memory 406 and search the discovery records 412 for one or more producer NF instances 204 that implement the desired producer NF 330. Upon determining, based on the search, one or more discovery records 412 including NF profiles of producer NF instances 204 that implement the producer NF 330, the SCP instance 350 selects a producer NF instance 204 from the determined discovery records 412 and extracts the network address of the selected producer NF instance 204 from a respective discovery record 412. Subsequently the SCP instance 350 forwards/routes the service request 240 to the producer NF instance 204 at the extracted network address of the producer NF instance 204.

In certain embodiments, when the SCP instance 350 finds more than one discovery record 412 each including a producer NF instance 204 implementing the desired producer NF 330, the SCP instance 350 may be configured to select the producer NF instance 204 from the most recent discovery record 412.

In some cases, the SCP instance 350 may not find a discovery record 412 including a producer NF instance 204 that implements the desired producer NF 330. For example, the SCP instance 350 may not have performed a discovery procedure associated with the desired producer NF 330, and thus, no discovery record 412 of a producer NF instance implementing the producer NF 330 may exist. In response to not finding a discovery record 412 including a producer NF instance 204 that implements the desired producer NF 330, the SCP instance 350 may fall back to a static configuration 414 stored in memory 406 and select the producer NF instance 204 from the static configuration 414. In this context, the SCP instance 350 may be configured to store the static configuration 414 that includes NF profiles (e.g., network addresses, services provided etc.) of pre-configured producer NF instances 204 implementing several network functions 130 of the 5G core network 114. In one embodiment, the static configuration 414 may include NF profiles of several pre-configured producer NF instances 204 for each network function 130. In other words, for a particular network function 130, the static configuration 414 may include NF profiles of several producer NF instances 204 that implement the particular network function 130. In one embodiment, in response to not finding a discovery record 412 including a producer NF instance 204 that implements the desired producer NF 330, the SCP instance 350 may be configured to select from the static configuration 414 a pre-configured producer NF instance 204 that implements the desired producer NF 330 and forwards/routes the service request 240 to the selected producer NF instance 204. In one embodiment, the static configuration 414 is same as or at least includes the static configuration 314 stored in memory 306 of the consumer NF instance 202. In an alternative or additional embodiment, the SCP instance 350 may send an indication to the consumer NF instance 202 of the failed NF discovery procedure, and in response, the consumer NF instance 202 may select a pre-configured producer NF instance 204 from the static configuration 314 stored in memory 306 as described with reference to FIG. 3.

In some cases, the SCP instance 350 may determine that the NRF instance 340 is available to process the discovery request 430 but may be unable to successfully complete the discovery procedure with the NRF instance 340. For example, after transmitting the discovery request 430 to the NRF instance 340, the SCP instance 350 may receive incomplete results, erroneous results, may receive a response indicating that no producer NF instance 204 was found, or may not receive results at all within a pre-configured time period. In response to not completing the discovery procedure with the NRF instance 340, the SCP instance 350 may fall back to the static configuration 414 stored in memory 406 and select a pre-configured producer NF instance 204 from the static configuration 414. Subsequently, the consumer NF instance 202 may forward/route the service request 240 to the selected producer NF instance 204.

The SCP instance 350 may be configured to check (e.g., according to a pre-configured schedule) an operational status of each producer NF instance 204 that is part of the static configuration 414. Checking the status of a particular producer NF instance 204 includes checking whether the particular producer NF instance 204 is operational and can communicate with the SCP instance 350 to provide a desired service to the consumer NF instance 202. For example, the SCP instance 350 may periodically transmit a status check message to a particular producer NF instance 204 from the static configuration 414 and upon not receiving a response within a pre-configured time determine that the particular producer NF instance 204 is unresponsive and thus non-operational. In response to determining that a particular producer NF instance 204 is not operational, the SCP instance 350 may be configured to flag the particular producer NF instance 204 as non-operational to prevent selection of the particular producer NF instance 204 for communication with the consumer NF instance 202.

In certain embodiments, in response to determining that the consumer NF 320 is to consume a service provided by the producer NF 330, the consumer NF instance 202 first checks the availability of the SCP instance 350 to perform delegated NF discovery on behalf of the consumer NF instance 202 and route messages between the consumer NF instance 202 and a selected producer NF instance 204 that implements the desired producer NF 330. In some cases, the SCP instance 350 may be unavailable because of an error and/or failure of the SCP instance 350, which may cause interruption in service. The consumer NF instance 202 may determine whether the SCP instance 350 is available to process a service request 240 in several ways. For example, the consumer NF instance 202 may periodically ping the SCP instance 350. The consumer NF instance 202 may determine that the SCP instance 350 is available if a response is received within a pre-configured time period. On the other hand, the consumer NF instance 202 may determine that the SCP instance 350 is unavailable in response to not receiving a response to a ping in the pre-configured time period. In an additional or alternative example, the consumer NF instance 202 may determine that the SCP instance 350 is available if a response to the service request 240 is received within a pre-configured time period. On the other hand, the consumer NF instance 202 may determine that the SCP instance 350 is unavailable to process the service request 240 in response to not receiving a response to the service request 240 within the pre-configured time period.

Upon detecting that the SCP instance 350 is unavailable to process the service request 240, the consumer NF instance 202 may be configured to fall back to model B communications as described above which does not use SCP 260 for communications between the consumer NF instance 202 and the producer NF instance 204.

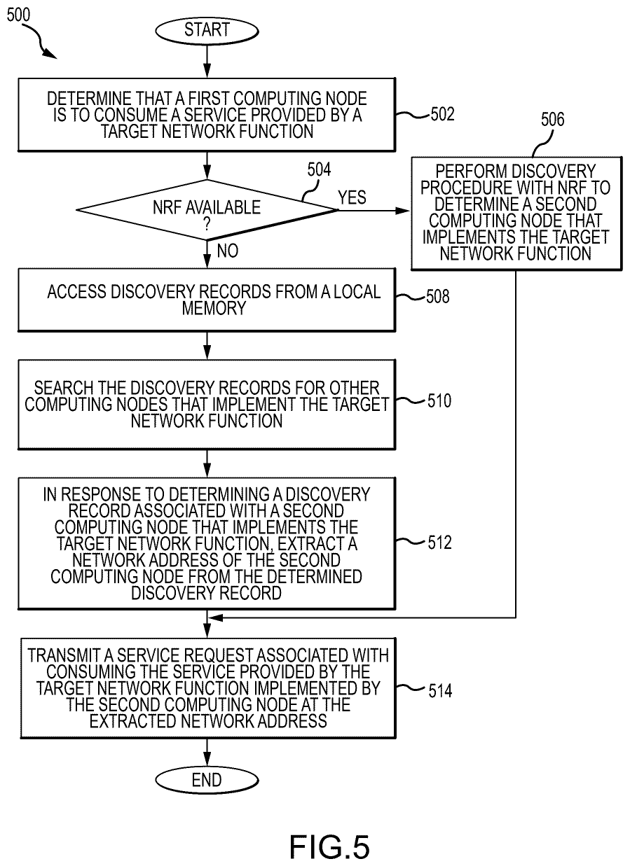

FIG. 5 is a flowchart of an example method 500 for service continuity in model B and C communications during NRF outage, in accordance with embodiments of the present disclosure. Method 500 may be performed by the consumer NF instance 202 as shown in FIG. 3 and described above.

At operation 502, the consumer NF instance 202 determines that the consumer NF instance 202 is to consume a service provided by a target network function (e.g., producer NF 330) associated with a 5G core network 114.

At operation 504, the consumer NF instance 202 determines whether the NRF 130c is available to process a request (e.g., discovery request 220/230) from the consumer NF instance 202 to perform a discovery procedure, wherein the discovery procedure includes determining one or more computing nodes (e.g., producer NF instances 204) that implement the target network function (e.g., producer NF 330).

As described above, when implementing NF-NF communication according to model B or model C, a consumer NF instance 202 implementing a consumer NF 320 performs a discovery procedure with an NRF instance 340 that implements the NRF 130c to determine a producer NF instance 204 that implements a producer NF 330 providing a desired service to be consumed by the consumer NF 320. For example, in response to determining that the consumer NF 320 is to consume a service provided by the producer NF 330, the consumer NF instance 202 transmits a discovery request 220 (model B)/230 (model C) to the NRF instance 340, wherein the discovery request 220/230 includes an indication of the producer NF 330 which provides a service to be consumed by the consumer NF 320. Generally, in response to receiving the discovery request 220/230, the NRF instance 340 searches for producer NF instances 204 that implement the desired producer NF 330 and transmits back NF profiles associated with one or more producer NF instances 204 that implement the desired producer NF 330, from which the consumer NF instance 202 may select a particular producer NF instance 204 for communication. However, in some cases, the consumer NF instance 202 may be unable to perform/complete the discovery procedure with the NRF instance 340 because of an error and/or failure of the NRF instance 340. The consumer NF instance 202 may determine whether the NRF instance 340 is available to perform the discovery procedure in several ways. For example, the consumer NF instance may periodically ping the NRF instance 340. The consumer NF instance 202 may determine that the NRF instance 340 is available if a response is received within a pre-configured time period. On the other hand, the consumer NF instance 202 may determine that the NRF instance 340 is unavailable in response to not receiving a response to a ping in the pre-configured time period. In an additional or alternative example, the consumer NF instance 202 may determine that the NRF instance 340 is available if a response to the discovery request 220/230 is received within a pre-configured time period. On the other hand, the consumer NF instance 202 may determine that the NRF instance 340 is unavailable to process the discovery request 220/230 in response to not receiving a response to the discovery request 220/230 within the pre-configured time period.

In response to determining that the NRF 130c is available to process the discovery request 220/230, method 500 proceeds to operation 506, where the consumer NF instance 202 performs a discovery procedure with the NRF to determine a producer NF instance 204 that implements the desired producer NF 330. On the other hand, in response to determining that the NRF 130c is unavailable to process the discovery request 220/230, method 500 proceeds to operation 508.

At operation 508, in response to determining that the NRF 130c is unavailable to process the discovery request 220/230, the consumer NF instance 202 accesses a local memory 306 of the consumer NF instance 202 that stores discovery records 312 of previous discovery procedures performed by the consumer NF instance 202, wherein each discovery record 312 includes discovery results of a previous discovery procedure performed by the consumer NF instance 202.

At operation 510, the consumer NF instance 202 searches the discovery records 312 for other computing nodes (e.g., producer NF instances 204), that implement the target network function (e.g., the producer NF 330).

As described above, upon detecting that the NRF instance 340 is unavailable to process the discovery request 220/230, the consumer NF instance 202 may be configured to access the discovery history 310 stored in the memory 306. The discovery history 310 stores discovery records 312 of previous discovery procedures performed by the consumer NF instance 202 with the NRF instance 340 or any other NRF instance that implements the NRF 130c. Each discovery record 312 includes results of a particular discovery procedure previously performed by the consumer NF instance 202, wherein the results may include, but are not limited to, NF profiles of one or more producer NF instances 204 including network address of the producer NF instances 204 and one or more services provided by each producer NF instance 204. 3GPP standards define a validity period associated with each NF instance determined as part of performing the discovery procedure with NRF 130c. Essentially, upon receiving discovery results from an NRF instance 340, the consumer NF instance 202 may communicate with and consume services from a producer NF instance 204 received as part of the discovery results only within the defined validity period. The producer NF instances 204 received as part of the discovery results from the NRF instance 340 become invalid upon expiration of the validity period. Generally, the consumer NF instance 202 deletes a discovery record 312 associated with a particular discovery procedure upon expiration of the validity period. However, in one or more embodiments, the consumer NF instance 202 may be configured to store the discovery records 312 beyond the respective validity periods (e.g., defined by 3GPP standards) associated with the respective discovery records 312. This allows the consumer NF instance 202 to use discovery results from a previously performed discovery procedure as a fallback option beyond the validity period of the discovery results and avoid service interruption in the event of NRF error/failure.

For example, upon detecting that the NRF instance 340 is unavailable to process the discovery request 220/230, the consumer NF instance 202 may be configured to access the discovery history 310 stored in the memory 306 and search the discovery records 312 for one or more producer NF instances 204 that implement the desired producer NF 330.

At operation 512, in response to determining (e.g., based on searching the discovery records 312) a discovery record 312 associated with a producer NF instance 204 that implements the target network function (e.g., the producer NF 330), the consumer NF instance 202 extracts a network address of the producer NF instance 204 from the determined discovery record 312.

As described above, upon determining, based on the search, one or more discovery records 312 including NF profiles of producer NF instances 204 that implement the producer NF 330, the consumer NF instance 202 selects a producer NF instance 204 from the determined discovery records 312 and extracts the network address of the selected producer NF instance 204 from a respective discovery record 312.

At operation 514, the consumer NF instance 202 transmits, at the extracted network address, a service request 224/234 associated with consuming the service provided by the target network function (e.g., the producer NF 330) implemented by the producer NF instance 204 that was identified from the discovery records 312.

As described above, when implementing model B communications, the consumer NF instance 202 transmits a service request 224 to the producer NF instance 204 at the extracted network address of the producer NF instance 204. When implementing model C communications, the consumer NF instance 202 transmits a service request 234 to the SCP instance 350, wherein the service request 234 includes an indication (e.g., NF profile, network address etc.) of the selected producer NF instance 204. The SCP instance 350 is then responsible to route the service request 234 to the producer NF instance 204 at the network address of the producer NF instance 204 received from the consumer NF instance 202.

In certain embodiments, when the consumer NF instance 202 finds more than one discovery record 312 each including a producer NF instance 204 implementing the desired producer NF 330, the consumer NF instance 202 may be configured to select the producer NF instance 204 from the most recent discovery record 312.

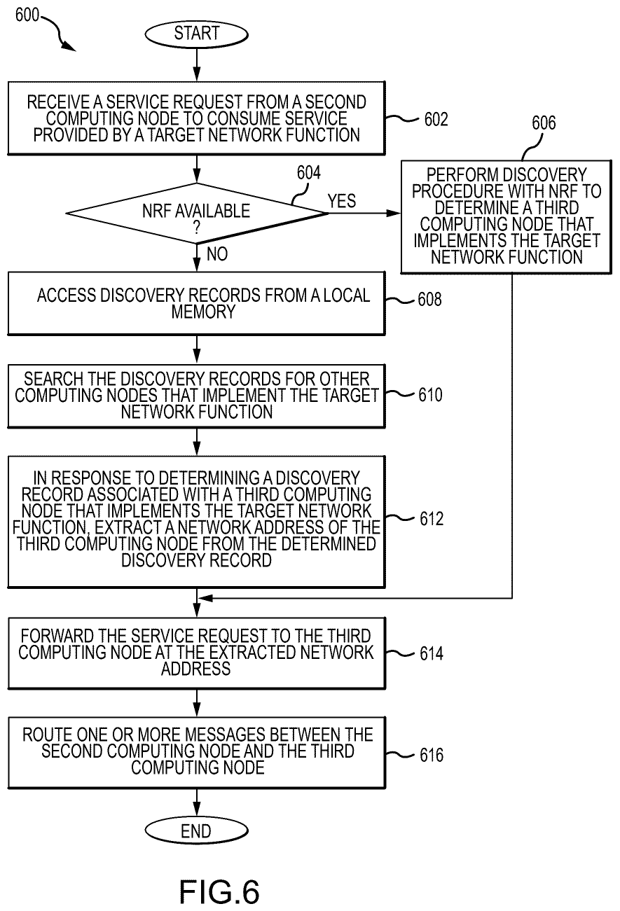

FIG. 6 is a flowchart of an example method 500 for service continuity in model D communications during NRF outage, in accordance with embodiments of the present disclosure. Method 600 may be performed by the SCP instance 350 as shown in FIG. 4 and described above.

At operation 602, the SCP instance 350 receives a service request 240 from a consumer NF instance 202 to consume a service provided by a target network function (e.g., producer NF 330) associated with a 5G core network 114.

At operation 604, the SCP instance 350 determines whether the NRF 130c is available to process a request (e.g., discovery request 430) from the SCP instance 350 to perform a discovery procedure, wherein the discovery procedure includes determining one or more computing nodes (e.g., producer NF instances 204) that implement the target network function (e.g., producer NF 330).

As described above, when implementing NF-NF communication according to model D, the SCP 260 is used for delegated NF discovery as well as to route messages between a consumer NF instance 202 and a producer NF instance 204. As shown in FIG. 4, in response to determining that the consumer NF 320 is to consume a service provided by the producer NF 330, the consumer NF instance 202 transmits a service request 240 including a set of discovery parameters 242 (shown in FIG. 2D) to the SCP instance 350. The discovery parameters 242 include an indication of the producer NF 330 from which the consumer NF instance 202 desires to consume a desired service. The SCP instance 350 performs a discovery procedure with the NRF instance 340 based on the discovery parameters 242 received from the consumer NF instance 202. For example, the SCP instance 350 transmits a discovery request 430 to the NRF instance 340, wherein the discovery request 430 includes an indication of the producer NF 330 which provides a service to be consumed by the consumer NF 320. Generally, in response to receiving the discovery request 430, the NRF instance 340 searches for producer NF instances 204 that implement the desired producer NF 330 and transmits back NF profiles associated with one or more producer NF instances 204 that implement the desired producer NF 330, from which the SCP instance 350 may select a particular producer NF instance 204 for communication with the consumer NF instance 202. However, in some cases, the SCP instance 350 may be unable to perform/complete the discovery procedure with the NRF instance 340 because of an error and/or failure of the NRF instance 340. The SCP instance 350 may determine whether the NRF instance 340 is available to perform the discovery procedure in several ways. For example, the SCP instance 350 may periodically ping the NRF instance 340. The SCP instance 350 may determine that the NRF instance 340 is available if a response is received within a pre-configured time period. On the other hand, the SCP instance 350 may determine that the NRF instance 340 is unavailable in response to not receiving a response to a ping in the pre-configured time period. In an additional or alternative example, the SCP instance 350 may determine that the NRF instance 340 is available if a response to the discovery request 430 is received within a pre-configured time period. On the other hand, the SCP instance 350 may determine that the NRF instance 340 is unavailable to process the discovery request 430 in response to not receiving a response to the discovery request 430 within the pre-configured time period.

In response to determining that the NRF 130c is available to process the discovery request 430, method 600 proceeds to operation 606, where the SCP instance 350 performs a discovery procedure with the NRF 130c to determine a producer NF instance 204 that implements the desired producer NF 330. On the other hand, in response to determining that the NRF 130c is unavailable to process the discovery request 430, method 600 proceeds to operation 608.

At operation 608, in response to determining that the NRF 130c is unavailable to process the discovery request 430, the SCP instance 350 accesses a local memory 406 of the SCP instance 350 that stores discovery records 412 of previous discovery procedures performed by the SCP instance 350, wherein each discovery record 412 includes discovery results of a previous discovery procedure performed by the SCP instance 350.

At operation 610, the SCP instance 350 searches the discovery records 412 for other computing nodes (e.g., producer NF instances 204), that implement the target network function (e.g., the producer NF 330).

As described above, upon detecting that the NRF instance 340 is unavailable to process the discovery request 430, the SCP instance 350 may be configured to access the discovery history 410 stored in the memory 406. The discovery history 410 stores discovery records 412 of previous discovery procedures performed by the SCP instance 350 with the NRF instance 340 or any other NRF instance that implements the NRF 130c. Each discovery record 412 includes results of a particular discovery procedure previously performed by the SCP instance 350, wherein the results may include, but are not limited to, NF profiles of one or more producer NF instances 204 including network address of the producer NF instances 204 and one or more services provided by each producer NF instance 204. 3GPP standards define a validity period associated with each computing node determined as part of performing the discovery procedure with NRF 130c. Essentially, upon receiving discovery results from an NRF instance 340, a producer NF instance 204 received as part of the discovery results may be used for communication with the consumer NF instance 202 only within the defined validity period. The producer NF instances 204 received as part of the discovery results from the NRF instance 340 become invalid upon expiration of the validity period. Generally, the SCP instance 350 deletes a discovery record 412 associated with a particular discovery procedure upon expiration of the validity period. However, in one or more embodiments, the SCP instance 350 may be configured to store the discovery records 412 beyond the respective validity periods (e.g., defined by 3GPP standards) associated with the respective discovery records 412. This allows the SCP instance 350 to use discovery results from a previously performed discovery procedure as a fallback option beyond the validity period of the discovery results and avoid service interruption in the event of NRF error/failure.

For example, upon detecting that the NRF instance 340 is unavailable to process the discovery request 430, the SCP instance 350 may be configured to access the discovery history 410 stored in the memory 406 and search the discovery records 412 for one or more producer NF instances 204 that implement the desired producer NF 330.

At operation 612, in response to determining (e.g., based on searching the discovery records 412) a discovery record 412 associated with a producer NF instance 204 that implements the target network function (e.g., the producer NF 330), the SCP instance 350 extracts a network address of the producer NF instance 204 from the determined discovery record 312.

At operation 614, the SCP instance 350 forwards the service request 240 to the identified producer NF instance 204 at the extracted network address.

At operation 616, the SCP instance 350 routes one or more messages between the consumer NF instance 202 and the identified producer NF instance 204 to allow the consumer NF 320 implemented by the consumer NF instance 202 to consume the service provided by the target network function (e.g., producer NF 330) implemented by the identified producer NF instance 204.

As described above, upon determining, based on searching the discovery history 410, one or more discovery records 412 including NF profiles of producer NF instances 204 that implement the producer NF 330, the SCP instance 350 selects a producer NF instance 204 from the determined discovery records 412 and extracts the network address of the selected producer NF instance 204 from a respective discovery record 412. Subsequently the SCP instance 350 forwards/routes the service request 240 to the producer NF instance 204 at the extracted network address of the producer NF instance 204.

In certain embodiments, when the SCP instance 350 finds more than one discovery record 412 each including a producer NF instance 204 implementing the desired producer NF 330, the SCP instance 350 may be configured to select the producer NF instance 204 from the most recent discovery record 412.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a first computing node of a plurality of computing nodes that implement a core network of a cellular network, wherein the first computing node implements a Service Communication Proxy (SCP) that is configured to perform one or more of a network function (NF) discovery procedure on behalf of the computing nodes implementing network functions associated with the core network or route data between the computing nodes;
a second computing node of the core network that implements a first network function of the network functions associated with the core network, wherein one or more computing nodes of the plurality of computing nodes of the core network implement the plurality of network functions associated with the core network, wherein one of the plurality of network functions is a network function (NF) repository function (NRF) that maintains a list of network function instances and associated NF profiles in the core network;
wherein the first computing node comprises a processor configured to:
receive a service request from the second computing node to consume a service provided by a target network function from the plurality of network functions associated with the core network;
determine whether the NRF is available to process a request from the first computing node to perform a discovery procedure, wherein the discovery procedure comprises determining one or more of the computing nodes that implement the target network function;
in response to determining that the NRF is unavailable to process the request to perform the discovery procedure, access a local memory of the first computing node that stores discovery records of previous discovery procedures performed by the first computing node, wherein each discovery record comprises discovery results of a previous discovery procedure performed by the first computing node;
search the discovery records for other computing nodes of the plurality of computing nodes that implement the target network function;
in response to determining, based on the search, a discovery record associated with a third computing node that implements the target network function, extract a network address of the third computing node from the determined discovery record;
forward the service request to the third computing node at the extracted network address; and
route one or more messages between the second computing node and the third computing node to allow the first network function implemented by the second computing node to consume the service provided by the target network function implemented by the third computing node.

2. The system of claim 1, wherein the processor is further configured to detect that the NRF is unavailable by:
transmitting the request to a fourth computing node of the core network that implements the NRF to perform the discovery procedure relating to determining the one or more computing nodes that implement the target network function;
detecting that a response to the request has not been received from the fourth computing node in a pre-configured time period starting from transmitting the request; and
in response to detecting that the response to the request has not been received from the fourth computing node in the pre-configured time period, determining that the NRF is unavailable to process the request.

3. The system of claim 1, wherein:
a validity period is defined associated with each computing node determined as part of performing the discovery procedure with the NRF; and
the local memory is configured to store the discovery records beyond the respective validity periods associated with the computing nodes related to the discovery records.

4. The system of claim 1, wherein the processor is further configured to:
in response to determining, based on the search, that no discovery records exist in the local memory of previous communications between the first computing node and other computing nodes that implement the target network function:
obtain a static configuration comprising one or more pre-configured fourth computing nodes that implement the target network function:
select a fourth computing node associated with the static configuration;
forward the service request to the selected fourth computing node; and
route one or more messages between the second computing node and the fourth computing node to allow the first network function implemented by the second computing node to consume the service provided by the target network function implemented by the fourth computing node.

5. The system of claim 4, wherein the static configuration is in accordance with model A communications defined by 3GPP (3^{rd} Generation Partnership Project) standards for communication between the network functions in the core network.

6. The system of claim 1, wherein the processor is further configured to:
determine that a fourth computing node implementing the NRF is available to process the request from the first computing node to perform the discovery procedure;
transmit the request to the fourth computing node to perform the discovery procedure;
in response to transmitting the request, receive from the fourth computing node a network profile of a fifth computing node that implements the target network function, wherein the network profile comprises a network address of the fifth computing node;
forward the service request to the fifth computing node; and
route one or more messages between the second computing node and the fifth computing node to allow the first network function implemented by the second computing node to consume the service provided by the target network function implemented by the fifth computing node.

7. The system of claim 1, wherein the processor is further configured to:
determine that a fourth computing node implementing the NRF is available to process the request from the first computing node to perform the discovery procedure;
transmit the request to the fourth computing node to perform the discovery procedure;
in response to transmitting the request, receive a response from the fourth computing node that comprises a blank record, an erroneous record, or an indication that no records were found in response to performing the discovery procedure;
in response to receiving the response, obtain a static configuration comprising one or more pre-configured fifth computing nodes that implement the target network function:
select a fifth computing node associated with the static configuration;
forward the service request to the selected fifth computing node; and
route one or more messages between the second computing node and the fifth computing node to allow the first network function implemented by the second computing node to consume the service provided by the target network function implemented by the fifth computing node.

8. A method for service continuity during failure of a network function (NF) repository function (NRF) comprising:
receiving, at a first computing node, a service request from a second computing node to consume a service provided by a target network function from a plurality of network functions associated with a core network of a cellular network, wherein:
the first computing node and the second computing node are from a plurality of computing nodes that implement the core network, wherein the first computing node implements a Service Communication Proxy (SCP) that is configured to perform one or more of a network function (NF) discovery procedure on behalf of the computing nodes implementing the network functions associated with the core network or route data between the computing nodes;
the second computing node implements a first network function of the network functions associated with the core network, wherein one or more computing nodes of the plurality of computing nodes of the core network implement the plurality of network functions associated with the core network, wherein one of the plurality of network functions is the NRF that maintains a list of network function instances and associated NF profiles in the core network;
determining whether the NRF is available to process a request from the first computing node to perform a discovery procedure, wherein the discovery procedure comprises determining one or more of the computing nodes that implement the target network function;
in response to determining that the NRF is unavailable to process the request to perform the discovery procedure, accessing a local memory of the first computing node that stores discovery records of previous discovery procedures performed by the first computing node, wherein each discovery record comprises discovery results of a previous discovery procedure performed by the first computing node;
searching the discovery records for other computing nodes of the plurality of computing nodes that implement the target network function;
in response to determining, based on the search, a discovery record associated with a third computing node that implements the target network function, extracting a network address of the third computing node from the determined discovery record;
forwarding the service request to the third computing node at the extracted network address; and
routing one or more messages between the second computing node and the third computing node to allow the first network function implemented by the second computing node to consume the service provided by the target network function implemented by the third computing node.

9. The method of claim 8, wherein detecting that the NRF is unavailable comprises:
transmitting the request to a fourth computing node of the core network that implements the NRF to perform the discovery procedure relating to determining the one or more computing nodes that implement the target network function;
detecting that a response to the request has not been received from the fourth computing node in a pre-configured time period starting from transmitting the request; and
in response to detecting that the response to the request has not been received from the fourth computing node in the pre-configured time period, determining that the NRF is unavailable to process the request.

10. The method of claim 8, wherein:
a validity period is defined associated with each computing node determined as part of performing the discovery procedure with the NRF; and
the local memory is configured to store the discovery records beyond the respective validity periods associated with the computing nodes related to the discovery records.

11. The method of claim 8, further comprising:
in response to determining, based on the search, that no discovery records exist in the local memory of previous communications between the first computing node and other computing nodes that implement the target network function:
obtaining a static configuration comprising one or more pre-configured fourth computing nodes that implement the target network function:
selecting a fourth computing node associated with the static configuration;
forwarding the service request to the selected fourth computing node; and
routing one or more messages between the second computing node and the fourth computing node to allow the first network function implemented by the second computing node to consume the service provided by the target network function implemented by the fourth computing node.

12. The method of claim 11, wherein the static configuration is in accordance with model A communications defined by 3GPP (3^{rd} Generation Partnership Project) standards for communication between the network functions in the core network.

13. The method of claim 8, further comprising:
determining that a fourth computing node implementing the NRF is available to process the request from the first computing node to perform the discovery procedure;
transmitting the request to the fourth computing node to perform the discovery procedure;
in response to transmitting the request, receiving from the fourth computing node a network profile of a fifth computing node that implements the target network function, wherein the network profile comprises a network address of the fifth computing node;
forwarding the service request to the fifth computing node; and
routing one or more messages between the second computing node and the fifth computing node to allow the first network function implemented by the second computing node to consume the service provided by the target network function implemented by the fifth computing node.

14. The method of claim 8, further comprising:
determining that a fourth computing node implementing the NRF is available to process the request from the first computing node to perform the discovery procedure;
transmitting the request to the fourth computing node to perform the discovery procedure;
in response to transmitting the request, receiving a response from the fourth computing node that comprises a blank record, an erroneous record, or an indication that no records were found in response to performing the discovery procedure;
in response to receiving the response, obtaining a static configuration comprising one or more pre-configured fifth computing nodes that implement the target network function:
selecting a fifth computing node associated with the static configuration;
forwarding the service request to the selected fifth computing node; and
routing one or more messages between the second computing node and the fifth computing node to allow the first network function implemented by the second computing node to consume the service provided by the target network function implemented by the fifth computing node.

15. A non-transitory computer-readable medium storing instructions that when executed by a processor causes the processor to:
receive, at a first computing node, a service request from a second computing node to consume a service provided by a target network function from a plurality of network functions associated with a core network of a cellular network, wherein:
the first computing node and the second computing node are from a plurality of computing nodes that implement the core network, wherein the first computing node implements a Service Communication Proxy (SCP) that is configured to perform one or more of a network function (NF) discovery procedure on behalf of the computing nodes implementing the network functions associated with the core network or route data between the computing nodes;
the second computing node implements a first network function of the network functions associated with the core network, wherein one or more computing nodes of the plurality of computing nodes of the core network implement the plurality of network functions associated with the core network, wherein one of the plurality of network functions is a network function (NF) repository function (NRF) that maintains a list of network function instances and associated NF profiles in the core network;
determine whether the NRF is available to process a request from the first computing node to perform a discovery procedure, wherein the discovery procedure comprises determining one or more of the computing nodes that implement the target network function;
in response to determining that the NRF is unavailable to process the request to perform the discovery procedure, access a local memory of the first computing node that stores discovery records of previous discovery procedures performed by the first computing node, wherein each discovery record comprises discovery results of a previous discovery procedure performed by the first computing node;
search the discovery records for other computing nodes of the plurality of computing nodes that implement the target network function;
in response to determining, based on the search, a discovery record associated with a third computing node that implements the target network function, extract a network address of the third computing node from the determined discovery record;
forward the service request to the third computing node at the extracted network address; and
route one or more messages between the second computing node and the third computing node to allow the first network function implemented by the second computing node to consume the service provided by the target network function implemented by the third computing node.

16. The non-transitory computer-readable medium of claim 15, wherein detecting that the NRF is unavailable comprises:
transmitting the request to a fourth computing node of the core network that implements the NRF to perform the discovery procedure relating to determining the one or more computing nodes that implement the target network function;
detecting that a response to the request has not been received from the fourth computing node in a pre-configured time period starting from transmitting the request; and
in response to detecting that the response to the request has not been received from the fourth computing node in the pre-configured time period, determining that the NRF is unavailable to process the request.

17. The non-transitory computer-readable medium of claim 15, wherein:
a validity period is defined associated with each computing node determined as part of performing the discovery procedure with the NRF; and
the local memory is configured to store the discovery records beyond the respective validity periods associated with the computing nodes related to the discovery records.

18. The non-transitory computer-readable medium of claim 15, wherein the instructions further cause the processor to:
in response to determining, based on the search, that no discovery records exist in the local memory of previous communications between the first computing node and other computing nodes that implement the target network function:
obtain a static configuration comprising one or more pre-configured fourth computing nodes that implement the target network function:
select a fourth computing node associated with the static configuration;
forward the service request to the selected fourth computing node; and
route one or more messages between the second computing node and the fourth computing node to allow the first network function implemented by the second computing node to consume the service provided by the target network function implemented by the fourth computing node.

19. The non-transitory computer-readable medium of claim 18, wherein the static configuration is in accordance with model A communications defined by 3GPP (3^{rd} Generation Partnership Project) standards for communication between the network functions in the core network.

20. The non-transitory computer-readable medium of claim 15, wherein the instructions further cause the processor to:
determine that a fourth computing node implementing the NRF is available to process the request from the first computing node to perform the discovery procedure;
transmit the request to the fourth computing node to perform the discovery procedure;
in response to transmitting the request, receive from the fourth computing node a network profile of a fifth computing node that implements the target network function, wherein the network profile comprises a network address of the fifth computing node;
forward the service request to the fifth computing node; and
route one or more messages between the second computing node and the fifth computing node to allow the first network function implemented by the second computing node to consume the service provided by the target network function implemented by the fifth computing node.
